(19) United States
(12) Patent Application Publication
(10) Pub. No.: US 2023/0070743 A1
(43) Pub. Date: Mar. 9, 2023

(54) ERRATIC STEERING WARNING DEVICE, AND METHOD FOR CONTROLLING ERRATIC STEERING WARNING

(71) Applicant: Isuzu Motors Limited, Tokyo (JP)

(72) Inventors: Yoshihira KANAZAWA, Fujisawa-shi, Kanagawa (JP); Naoki TAKAHASHI, Fujisawa-shi, Kanagawa (JP); Tomoharu AOKI, Fujisawa-shi, Kanagawa (JP); Kazuya OGAWA, Fujisawa-shi, Kanagawa (JP)

(73) Assignee: Isuzu Motors Limited, Tokyo (JP)

(21) Appl. No.: 17/794,644

(22) PCT Filed: Jan. 27, 2021
(86) PCT No.: PCT/JP2021/002813

§ 371 Date: Jul. 22, 2022

(30) Foreign Application Priority Data
Jan. 27, 2020 (JP) 2020-010794

(51) Int. Cl. B60W 50/14; B60W 40/08; B60W 30/12

(52) U.S. Cl. CPC B60W 50/14; B60W 40/08; B60W 30/12; B60W 2050/143; B60W 2050/146; B60W 2540/223

(57) ABSTRACT

Provided are an erratic steering warning device, and a method for controlling an erratic steering warning, capable of suppressing unnecessary warning outputs. The erratic steering warning device includes: an erratic travel detecting unit for detecting erratic travel of a vehicle; and a warning output control unit which, if erratic travel has been detected, does not cause a warning to be output from a warning output unit if control is being executed to prevent the vehicle deviating from a lane, and a driver is not touching a steering operation unit that accepts a vehicle steering operation.

### TECHNICAL FIELD

The present disclosure relates to a sway warning apparatus and a sway warning control method.

### BACKGROUND ART

There has been known an apparatus that gives a warning to a driver when a vehicle sway traveling is detected (see, for example, Patent Literature 1).

### CITATION LIST

### Patent Literature

### PTL 1

Japanese Patent Application Laid-Open No. 2014-115983

### SUMMARY OF INVENTION

### Technical Problem

Incidentally, a steering angle sometimes frequently varies during the operation of a lane keeping assistant system (LKAS). The conventional apparatus, however, possibly detects the steering angle variation as sway traveling, which causes a problem of unnecessary warning output.

It is an object of the present disclosure to provide a sway warning apparatus and a sway warning control method each capable of reducing unnecessary warning output.

### Solution to Problem

A sway warning apparatus according to an embodiment of the present disclosure includes: a sway traveling detection section that detects sway traveling of a vehicle; and a warning output control section that causes a warning output section not to output a warning when the sway traveling is detected while control for preventing lane departure of the vehicle is in progress and a driver makes no contact with a steering operation section receiving a steering operation for the vehicle.

A sway warning control method according to an embodiment of the present disclosure includes: detecting, by an apparatus mounted on a vehicle, sway traveling of the vehicle; and causing, by the apparatus mounted on the vehicle, a warning output section not to output a warning when the sway traveling is detected while control for preventing lane departure of the vehicle is in progress and a driver makes no contact with a steering operation section receiving a steering operation for the vehicle.

### Advantageous Effects of Invention

According to the present disclosure, it is possible to reduce unnecessary warning output.

### BRIEF DESCRIPTION OF DRAWINGS

FIG. 1 is a block diagram illustrating configurations of a vehicle and a sway warning apparatus according to an embodiment of the present disclosure; and

FIG. 2 is a flowchart describing an operation procedure for the sway warning apparatus according to an embodiment of the present disclosure.

### DESCRIPTION OF EMBODIMENTS

Hereinafter, an embodiment of the present disclosure will be described in detail with reference to the accompanying drawings.

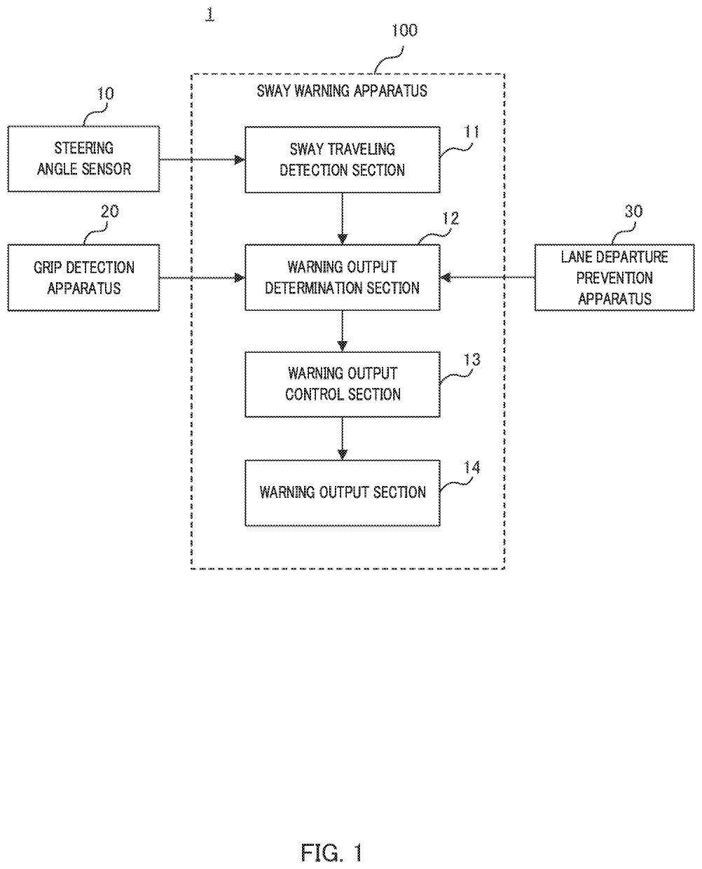

First, configurations of vehicle 1 and sway warning apparatus 100 according to an embodiment of the present disclosure will be described with reference to FIG. 1. FIG. 1 is a block diagram illustrating configurations of vehicle 1 and sway warning apparatus 100.

Vehicle 1 is, for example, an automobile, and may be a passenger car or a commercial vehicle.

As illustrated in FIG. 1, vehicle 1 includes steering angle sensor 10, grip detection apparatus 20, lane departure prevention apparatus 30, and sway warning apparatus 100.

Steering angle sensor 10 is a device that detects a steering angle of a steering wheel (not illustrated). Steering angle sensor 10 outputs steering angle information indicating the detected steering angle to sway traveling detection section 11 of sway warning apparatus 100.

Grip detection apparatus 20 is an apparatus that detects whether the steering wheel is gripped by a driver. When detecting the driver's grip on the steering wheel, grip detection apparatus 20 outputs grip detection information indicating the grip to warning output determination section 12 of sway warning apparatus 100. The processing for detecting a grip on a steering wheel is well-known, and thus the description thereof is omitted. Note that the steering wheel corresponds to an exemplary steering operation section that receives a steering operation for vehicle 1.

Lane departure prevention apparatus 30 is an apparatus that performs lane departure prevention control for preventing lane departure of traveling vehicle 1 based on a detection result from, for example, a steering wheel angle sensor, a camera, and a vehicle speed sensor (none of them are illustrated) mounted on vehicle 1. Lane departure prevention apparatus 30 is also referred to as a lane keeping assistant system (LKAS). The lane departure prevention control is well-known, and thus the description thereof is omitted.

Lane departure prevention apparatus 30 indicates the start of the lane departure prevention control to sway warning apparatus 100 when starting the control, and indicates the end of the lane departure prevention control to sway warning apparatus 100 when finishing the control. To be more specific, lane departure prevention apparatus 30 outputs control indication information indicating either the start or end of the lane departure prevention control to warning output determination section 12 of sway warning apparatus 100.

Sway warning apparatus 100 includes sway traveling detection section 11, warning output determination section 12, warning output control section 13, and warning output section 14.

Although not illustrated, sway warning apparatus 100 includes, as hardware, a central processing unit (CPU), a read only memory (ROM) storing a computer program, and a random access memory (RAM), for example. The functions of sway warning apparatus 100 to be described below are implemented by running a computer program read from the ROM by the CPU.

Sway traveling detection section 11 detects sway traveling of vehicle 1 based on the steering angle information received from steering angle sensor 10. The processing for detecting sway traveling based on a steering angle is well-known, and thus the description thereof is omitted.

When detecting sway traveling of vehicle 1, sway traveling detection section 11 indicates the fact to warning output determination section 12. To be more specific, sway traveling detection section 11 outputs to warning output determination section 12 detection indication information indicating that sway traveling of vehicle 1 is detected.

Note that, in the present embodiment, sway traveling detection section 11 detects sway traveling based on a steering angle, by way of example, but the detection method is not limited to this. For example, sway traveling may be detected based on acceleration data of vehicle 1 in the right-left direction or another well-known parameter.

Warning output determination section 12 recognizes that the sway traveling is detected when receiving the detection indication information from sway traveling detection section 11. Warning output determination section 12 then determines whether the lane departure prevention control is in progress based on the control indication information from lane departure prevention apparatus 30.

When the control indication information indicating the start of the lane departure prevention control has been received from lane departure prevention apparatus 30, warning output determination section 12 determines that the lane departure prevention control is in progress.

When the control indication information indicating the end of the lane departure prevention control has been received from lane departure prevention apparatus 30, in contrast, warning output determination section 12 determines that the lane departure prevention control is not in progress.

When determining that the lane departure prevention control is not in progress, warning output determination section 12 outputs to warning output control section 13 determination result information indicating that the lane departure prevention control is not in progress.

When determining that the lane departure prevention control is in progress, in contrast, warning output determination section 12 determines whether the steering wheel is gripped by a driver.

When the grip detection information has been received from grip detection apparatus 20, warning output determination section 12 determines that the steering wheel is gripped. Then, warning output determination section 12 outputs to warning output control section 13 determination result information indicating that the lane departure prevention control is in progress and the steering wheel is gripped.

Meanwhile, when the grip detection information has not been received from grip detection apparatus 20, warning output determination section 12 determines that the steering wheel is not gripped. Then, warning output determination section 12 outputs to warning output control section 13 determination result information indicating that the lane departure prevention control is in progress and the steering wheel is not gripped.

Warning output control section 13 gives a warning output instruction to warning output section 14 when the determination result information received from warning output determination section 12 indicates that the lane departure prevention control is not in progress, or indicates that the lane departure prevention control is in progress and the steering wheel is gripped.

Warning output control section 13 gives a no warning output instruction to warning output section 14 when the determination result information received from warning output determination section 12 indicates that the lane departure prevention control is in progress and the steering wheel is not gripped.

When the warning output instruction is given from warning output control section 13, warning output section 14 outputs a warning.

The warning may be, for example, an alarm sound from speakers on the right and left doors, or an image on a display provided on an instrument panel of a driver's seat. By outputting the warning in this manner, an occupant in vehicle 1 can recognize that vehicle 1 is swaying.

When the no warning output instruction is given from warning output control section 13, warning output section 14 does not output the warning.

The configurations of vehicle 1 and sway warning apparatus 100 have been described, thus far.

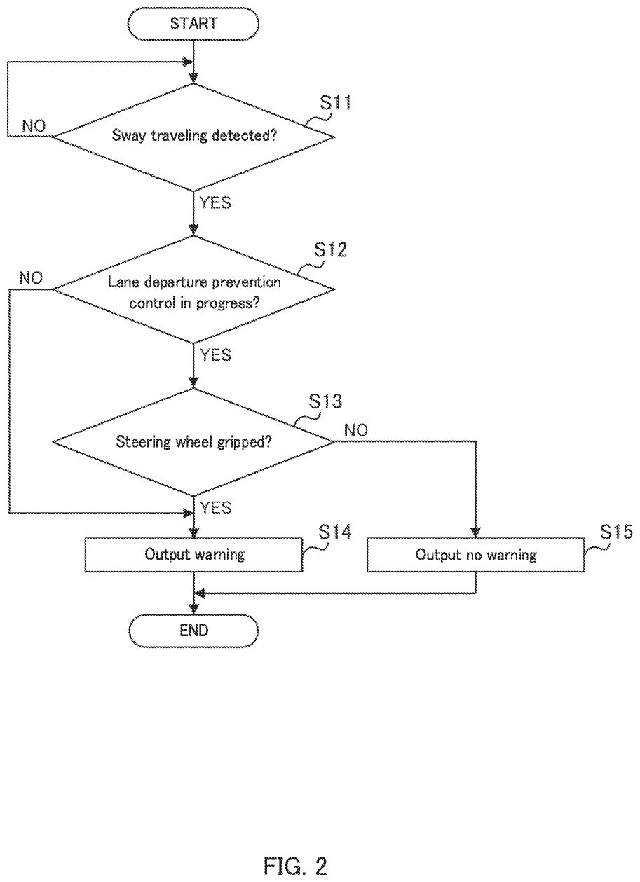

In the following, an operation of sway warning apparatus 100 will be described with reference to FIG. 2. FIG. 2 is a flowchart describing an operation procedure for sway warning apparatus 100. The procedure described in FIG. 2 is initiated when vehicle 1 starts traveling, for example.

In step S11, sway traveling detection section 11 detects sway traveling of vehicle 1 based on the steering angle information from steering angle sensor 10.

When no sway traveling of vehicle 1 is detected (step S11: NO), the procedure returns to step S11.

When sway traveling of vehicle 1 is detected (step S11: YES), in contrast, the procedure proceeds to step S12. In this case, sway traveling detection section 11 outputs the detection indication information to warning output determination section 12. This allows warning output determination section 12 to recognize that the sway traveling is detected.

In step S12, warning output determination section 12 determines whether the lane departure prevention control is in progress based on the control indication information received from lane departure prevention apparatus 30.

When it is determined that the lane departure prevention control is not in progress, (step S12: NO), the procedure proceeds to step S14. In this case, warning output determination section 12 outputs to warning output control section 13 the determination result information indicating that the lane departure prevention control is not in progress.

When it is determined that the lane departure prevention control is in progress, (step S12: YES), in contrast, the procedure proceeds to step S13.

In step S13, warning output determination section 12 determines whether the steering wheel is gripped by a driver based on whether the grip detection information has been received from grip detection apparatus 20.

When it is determined that the steering wheel is gripped (step S13: YES), the procedure proceeds to step S14. In this case, warning output determination section 12 outputs to warning output control section 13 the determination result information indicating that the lane departure prevention control is in progress and the steering wheel is gripped.

Meanwhile, when it is determined that the steering wheel is not gripped (step S13: NO), the procedure proceeds to step S15. In this case, warning output determination section 12 outputs to warning output control section 13 the determination result information indicating that the lane departure prevention control is in progress and the steering wheel is not gripped.

In step S14, warning output control section 13 instructs warning output section 14 to output a warning. This causes warning output section 14 to output a warning.

In step S15, warning output control section 13 instructs warning output section 14 not to output a warning. This causes warning output section 14 not to output a warning.

The operation of sway warning apparatus 100 has been described, thus far.

As described in detail above, sway warning apparatus 100 according to the present embodiment is characterized by outputting no warning when the sway traveling is detected while the lane departure prevention control is in progress and the steering wheel is not gripped.

Therefore, sway warning apparatus 100 according to the present embodiment can reduce unnecessary warning output.

Note that the present disclosure is not limited to the embodiment described above, and can be implemented with modifications as appropriate without departing from the spirit of the present disclosure.

The disclosure of Japanese Patent Application No. 2020-010792, filed on Jan. 27, 2020, including the specification, drawings and abstract, is incorporated herein by reference in its entirety.

### INDUSTRIAL APPLICABILITY

A sway warning apparatus and a sway warning control method of the present disclosure are useful for warning output when vehicle sway traveling is detected.

### REFERENCE SIGNS LIST

1 Vehicle
10 Steering angle sensor
11 Sway traveling detection section
12 Warning output determination section
13 Warning output control section
14 Warning output section
20 Grip detection apparatus
30 Lane departure prevention apparatus
100 Sway warning apparatus

1. A sway warning apparatus, comprising:
a sway traveling detection section that detects sway traveling of a vehicle; and
a warning output control section that causes a warning output section not to output a warning when the sway traveling is detected while control for preventing lane departure of the vehicle is in progress and a driver makes no contact with a steering operation section receiving a steering operation for the vehicle.

2. The sway warning apparatus according to claim 1, wherein the warning output control section causes the warning output section to output the warning when the sway traveling is detected while the control is in progress and a driver makes contact with the steering operation section.

3. The sway warning apparatus according to claim 1, wherein the warning output control section causes the warning output section to output the warning when the sway traveling is detected while the control is not in progress.

4. The sway warning apparatus according to claim 1, wherein the steering operation section is a steering wheel.

5. A sway warning control method, comprising:
detecting, by an apparatus mounted on a vehicle, sway traveling of the vehicle; and
causing, by the apparatus mounted on the vehicle, a warning output section not to output a warning when the sway traveling is detected while control for preventing lane departure of the vehicle is in progress and a driver makes no contact with a steering operation section receiving a steering operation for the vehicle.

6. The sway warning control method according to claim 5, further comprising:
causing, by the apparatus mounted on the vehicle, the warning output section to output the warning when the sway traveling is detected while the control is in progress and a driver makes contact with the steering operation section.

7. The sway warning control method according to claim 5, further comprising:
causing, by the apparatus mounted on the vehicle, the warning output section to output the warning when the sway traveling is detected while the control is not in progress.

8. The sway warning control method according to claim 5, wherein the steering operation section is a steering wheel.
